(19) United States
(12) Patent Application Publication
(10) Pub. No.: US 2025/0156322 A1
(43) Pub. Date: May 15, 2025

(54) SINGLE-PHASE COMMIT FOR REPLICATED CACHE DATA

(71) Applicant: Microsoft Technology Licensing, LLC, Redmond, WA (US)

(72) Inventors: Yingrui TONG, Shanghai (CN); Sijia HUANG, Shanghai (CN); Vadim MAKHERVAKS, Bellevue, WA (US); Yuxing ZHOU, Shanghai (CN); Junxiang WANG, Shanghai (CN); Zhihao LIU, Shanghai (CN); Bangzhu ZHU, Kunming (CN); Xigeng SUN, Shanghai (CN)

(21) Appl. No.: 18/587,258

(22) Filed: Feb. 26, 2024

Related U.S. Application Data
(60) Provisional application No. 63/598,426, filed on Nov. 13, 2023.

(51) Int. Cl. G06F 12/0802; G06F 9/455

(52) U.S. Cl. CPC G06F 12/0802; G06F 9/45558; G06F 2009/45579; G06F 2009/45583

(57) ABSTRACT

A computer system and method are disclosed for replicating logs in a distributed environment. The method includes identifying a write input/output (I/O) operation and identifying a log to be replicated based on the write I/O operation. The log is then persisted to local non-volatile memory in the computer system. Subsequently, the log is replicated to multiple remote hosts, where each remote host of the plurality of remote hosts stores the log in its corresponding local non-volatile memory without de-staging the log to a backing store. The write I/O operation is committed once the log is replicated to at least a subset of the remote hosts that forms a quorum. Finally, the log is de-staged to the backing store after the write I/O operation is successfully committed.

### CROSS-REFERENCE TO RELATED APPLICATIONS

This application claims priority to, and the benefit of, U.S. Provisional Application Ser. No. 63/598,426, filed Nov. 13, 2023, and entitled “SINGLE-PHASE COMMIT FOR REPLICATED CACHE DATA,” the entire contents of which are incorporated by reference herein in their entirety.

### BACKGROUND

Cloud computing has revolutionized the way data is stored and accessed, providing scalable, flexible, and cost-effective solutions for businesses and individuals alike. A core component of these systems is the concept of virtualization, which allows for the creation of virtual machines (VMs) or containers that can utilize resources abstracted from the physical hardware. VMs and containers utilize storage resources, typically in the form of virtual disks. Oftentimes, virtual disks are not tied to any specific physical storage device, but rather, they are abstracted representations of storage space that can be dynamically allocated and adjusted based on the requirements of each VM or container. This abstraction allows for greater flexibility and scalability, as storage resources can be allocated and adjusted dynamically based on the requirements of the VM or container.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: identifying a write input/output (I/O) operation; identifying a log to be replicated based on the write I/O operation; persisting the log to local non-volatile memory in the computer system; replicating the log to a plurality of remote hosts, wherein each remote host of the plurality of remote hosts stores the log in a corresponding local non-volatile memory in the remote host; committing the write I/O operation after replicating the log to at least a subset of the plurality of remote hosts that includes a quorum; and de-staging the log to the backing store based on committing the write I/O operation.

In some aspects, the techniques described herein relate to methods, systems, and computer program products, including: identifying a write I/O operation; identifying a log to be replicated based on the write I/O operation; persisting the log to local non-volatile memory in the computer system; replicating the log to a plurality of remote hosts, wherein each remote host of the plurality of remote hosts stores the log in a corresponding local non-volatile memory in the remote host without de-staging the log to a backing store; committing the write I/O operation after replicating the log to at least a subset of the plurality of remote hosts that includes a quorum, wherein the quorum includes less than a majority of the plurality of remote hosts; and de-staging the log to the backing store based on committing the write I/O operation.

In some aspects, the techniques described herein relate to methods, systems, and computer program products, including: identifying a write I/O operation; identifying a log to be replicated based on the write I/O operation; persisting the log to a persistent non-volatile memory in a computer system; replicating the log to a plurality of remote hosts, wherein each remote host of the plurality of remote hosts stores the log in a corresponding local non-volatile memory in the remote host without de-staging the log to a backing store; committing the write I/O operation after replicating the log to at least a subset of the plurality of remote hosts that includes a quorum; and de-staging the log to the backing store based on committing the write I/O operation.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that includes a host cache service operating within a cloud environment.

FIG. 2 illustrates an example of storing multiple data and metadata rings within a memory.

FIG. 3 illustrates an example of a computer architecture for replicating write cache data using a single-phase commit flow.

FIG. 4 illustrates an example of log statuses and pointers.

FIG. 5 illustrates an example of log replication.

FIG. 6 illustrates a flow chart of an example of a method for a primary host to replicate write input/output cache data to a replication set of secondary hosts.

### DETAILED DESCRIPTION

The performance of cloud environments is closely tied to the performance of storage Input/Output (I/O) operations within those environments. For example, the performance of a virtual machine (VM) or container can be impacted greatly by the performance of storage I/O operations used by the VM or container to access (e.g., read from or write to) a virtual disk. Some embodiments described herein are operable within the context of a host cache (e.g., a cache service operating at a VM/container host) that improves the performance of I/O operations of a hosted VM or container for accessing a virtual disk.

In some embodiments, a host cache utilizes persistent memory (PMem) and Non-Volatile Memory Express (NVMe) technologies to improve storage I/O performance within a cloud environment. PMem refers to non-volatile memory technologies (e.g., INTEL OPTANE, SAMSUNG Z-NAND) that retain stored contents through power cycles. This contrasts with conventional volatile memory technologies such as dynamic random-access memory (DRAM) that lose stored contents through power cycles. Some PMem technology is available as non-volatile media that fits in a computer's standard memory slot (e.g., Dual Inline Memory Module, or DIMM, memory slot) and is thus addressable as random-access memory (RAM).

NVMe refers to a type of non-volatile block storage technology that uses the Peripheral Component Interconnect Express (PCIe) bus and is designed to leverage the capabilities of high-speed storage devices like solid-state drives (SSDs), providing faster data transfer rates compared to traditional storage interfaces (e.g., Serial AT Attachment (SATA)). NVMe devices are particularly beneficial in data-intensive applications due to their low latency I/O and high I/O throughput compared to SATA devices. NVMe devices can also support multiple I/O queues, which further enhance their performance capabilities.

Currently, PMem devices have slower I/O access times than DRAM, but they provide higher I/O throughput than SSD and NVMe. Compared to DRAM, PMem modules come in much larger capacities and are less expensive per gigabyte (GB), but they are more expensive per GB than NVMe. Thus, PMem is often positioned as lower-capacity “top-tier” high-performance non-volatile storage that can be backed in a “lower-tier” by larger-capacity NVMe drives, SSDs, and the like. As a result, PMem is sometimes referred to as “storage-class memory.”

In embodiments, a host cache improves the performance of storage I/O operations of VMs and/or containers to their virtual disks by utilizing NVMe protocols. For example, some embodiments use a virtual NVMe controller to expose virtual disks to VMs and/or containers, enabling those VMs/containers to utilize NVMe queues, buffers, control registers, etc., directly. Additionally, or alternatively, a host cache improves the performance of storage I/O operations of VMs and/or containers to their virtual disks by leveraging PMem as high-performance non-volatile storage for caching reads and/or writes.

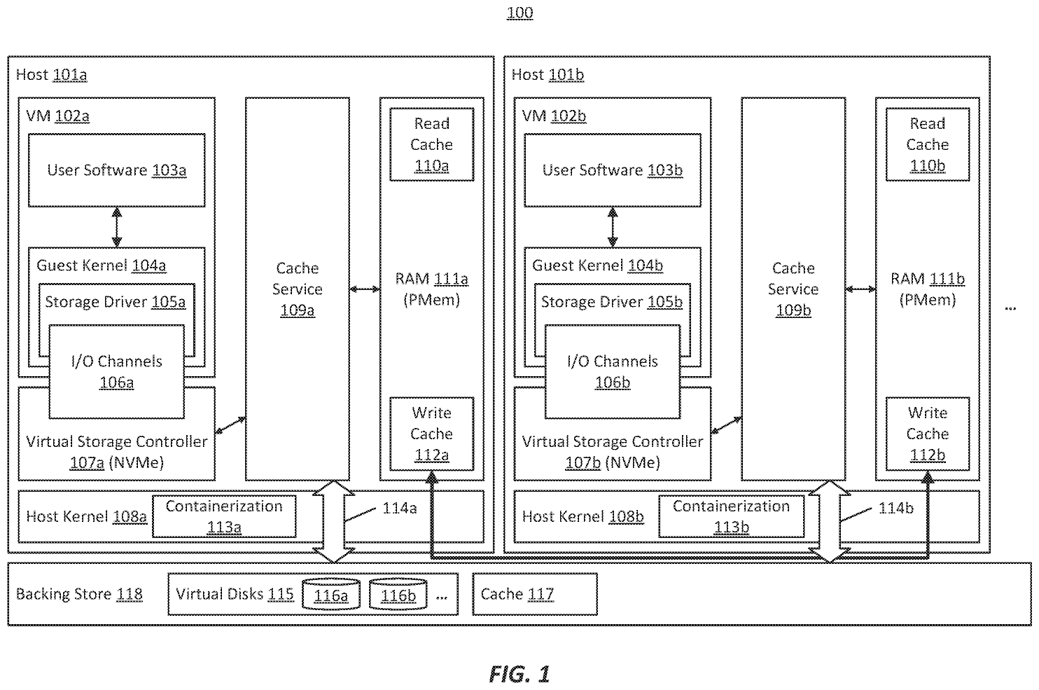

FIG. 1 illustrates an example of a host cache service operating within a cloud environment 100. In FIG. 1, cloud environment 100 includes hosts (e.g., host 101a, host 101b; collectively, hosts 101). An ellipsis to the right of host 101b indicates that hosts 101 can include any number of hosts (e.g., one or more hosts). In embodiments, each host is a VM host and/or a container host. Cloud environment 100 also includes a backing store 118 (or a plurality of backing stores) storing, e.g., virtual disks 115 (e.g., virtual disk 116a, virtual disk 116b) for use by VMs/containers operating at hosts 101, de-staged cache data (e.g., cache 117), etc.

In the example of FIG. 1, each host of hosts 101 includes a corresponding host operating system (OS) including a corresponding host kernel (e.g., host kernel 108a, host kernel 108b) that each includes (or interoperates with) a containerization component (e.g., containerization component 113a, containerization component 113b) that supports the creation of one or more VMs and/or one or more containers at the host. Examples of containerization components include a hypervisor (or elements of a hypervisor stack) and a containerization engine (e.g., AZURE container services, DOCKER, LINUX Containers). In FIG. 1, each host of hosts 101 includes a VM (e.g., VM 102a, VM 102b). VM 102a and VM 102b are each shown as including a guest kernel (e.g., guest kernel 104a, guest kernel 104b) and user software (e.g., user software 103a, user software 103b).

In FIG. 1, each host of hosts 101 includes a host cache service (e.g., cache service 109a, cache service 109b). In embodiments, a storage driver (e.g., storage driver 105a, storage driver 105b) at each VM/container interacts, via one or more I/O channels (e.g., I/O channels 106a, I/O channels 106b) with a virtual storage controller (e.g., virtual storage controller 107a, virtual storage controller 107b) for its I/O operations, such as I/O operations for accessing virtual disks 115. In embodiments, each host cache service communicates with a virtual storage controller to cache these I/O operations. As one example, in FIG. 1, the virtual storage controllers are shown as being virtual NVMe controllers. In this example, the I/O channels comprise NVMe queues (e.g., administrative queues, submission queues, completion queues), buffers, control registers, and the like.

In embodiments, each host cache service at least temporarily caches reads (e.g., read cache 110a, read cache 110b) and/or writes (e.g., write cache 112a, write cache 112b) in memory (e.g., RAM 111a, RAM 111b). As shown, in some embodiments, memory includes non-volatile PMem. For example, a read cache stores data that has been read (and/or that is predicted to be read) by VMs from backing store 118 (e.g., virtual disks 115), which can improve read I/O performance for those VMs (e.g., by serving reads from the read cache if that data is read more than once). A write cache, on the other hand, stores data that has been written by VMs to virtual disks 115 prior to persisting that data to backing store 118. Write caching allows for faster write operations, as the data can be written to the write cache quickly and then be written to the backing store 118 at a later time (e.g., when the backing store 118 is less busy).

In embodiments, and as indicated by arrow 114a and arrow 114b, each host cache service may persist (e.g., de-stage) cached writes from memory to backing store 118 (e.g., to virtual disks 115 and/or to cache 117). In addition, an arrow that connects write cache 112a and write cache 112b indicates that, in some embodiments, the host cache service replicates cached writes from one host to another (e.g., from host 101a to host 101b, or vice versa).

In embodiments, each write cache (write cache 112a, write cache 112b) is a write-ahead log that is stored as one or more ring buffers in memory (e.g., RAM 111a, RAM 111b). Write-ahead logging (WAL) refers to techniques for providing atomicity and durability in database systems. Write-ahead logs generally include append-only data structures that are used for crash and transaction recovery. With WAL, changes are first recorded as a log entry in a log (e.g., write cache 112a, write cache 112b) and are then written to stable storage (e.g., backing store 118) before the changes are considered committed. A ring buffer is a data structure that uses a single, fixed-size buffer as if connected end-to-end. That is, once the size of the buffer is exceeded, a new buffer replaces the oldest buffer entry.

In embodiments, for each write request from a VM, the host cache service stores a log entry comprising 1) a data portion comprising the data that was written by the VM as part of the write request (e.g., one or more memory pages to be persisted to virtual disks 115), and 2) a metadata portion describing the log entry and the write—e.g., a log identifier, a logical block address (LBA) for the memory page(s) in the data portion, and the like. In embodiments, data portions have a size that aligns cleanly in memory, including in a central processing unit (CPU) cache. For example, if a data portion represents n memory page(s), then the data portion is sized as a multiple of the size of each memory page in RAM 111a, RAM 111b (e.g., a multiple of four kilobytes (KB), a multiple of sixteen KB). If the metadata portion of each log is stored adjacent to its data portion in memory, then this memory alignment is broken. For instance, if the data portion of a log is n memory pages, and the metadata portion of that log is 32 bytes, then that log would require the entirety of n memory pages plus 32 bytes of a final memory page, which wastes most of the final memory page. Additionally, logs sized as n memory pages plus metadata would not fit cleanly across CPU cache lines, eliminating the ability to apply bitwise operations (e.g., for address searching).

In some embodiments, a host cache service utilizes separate ring buffers for data and metadata, which enables the host cache service to maintain clean memory alignments when storing write cache logs. A clean memory alignment refers to arranging data in memory so that it is aligned to certain boundaries, such as memory page sizes, cache line sizes, etc. Maintaining a clean memory alignment can improve memory access performance because aligned data maps to cache line sizes, improving cache hit rates; because an aligned memory access is generally faster for a processor to complete than a non-aligned memory access; and/or because an aligned memory access can avoid some processor exceptions that may otherwise occur with a non-aligned memory access.

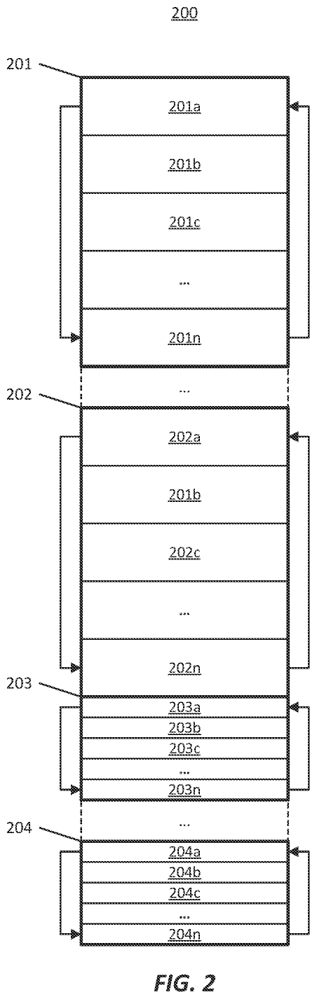

FIG. 2 illustrates an example 200 of storing multiple data and metadata rings within a memory. In example 200, memory is shown as storing a data ring 201 and a data ring 202, each comprising a plurality of entries (e.g., entry 201a to entry 201n for data ring 201 and entry 202a to entry 202n for data ring 202). Arrows indicate that entries are used circularly within each data ring, and an ellipsis within each data ring indicates that a data ring can comprise any number of entries. As indicated by an ellipsis between data ring 201 and data ring 202, in embodiments, a memory can store any number of data rings (e.g., one or more data rings). In some embodiments, multiple data rings are stored contiguously within the memory. Thus, in these embodiments, multiple metadata rings are stored one after the other within the memory.

In example 200, the memory is shown as also storing a metadata ring 203 and a metadata ring 204, each comprising a plurality of entries (e.g., entry 203a to entry 203n for metadata ring 203 and entry 204a to entry 204n for metadata ring 204). Arrows indicate that entries are used circularly within each metadata ring, and an ellipsis within each metadata ring indicates that a metadata ring can comprise any number of entries. As indicated by an ellipsis between metadata ring 203 and metadata ring 204, in embodiments, a memory can store any number of metadata rings (e.g., one or more metadata rings). In some embodiments, multiple metadata rings are stored contiguously within the memory (e.g., one after the other). In some embodiments, a block of data rings and a block of metadata rings are stored contiguously with each other within the memory (e.g., contiguous data rings, then contiguous metadata rings).

In embodiments, each metadata ring corresponds to a different data ring. For example, in example 200, metadata ring 203 corresponds to data ring 201, and metadata ring 204 corresponds to data ring 202. In embodiments, each entry in a metadata ring corresponds to a corresponding entry in a data ring (and vice versa). For example, entries 203a-203n correspond to entries 201a-201n, respectively, and entries 204a-204n correspond to entries 202a-202n, respectively.

In some embodiments, each pairing of data and metadata rings corresponds to a different entity, such as a VM or container, for which data is cached. This enables the data cached for each entity to be separated and localized within memory.

In embodiments, by storing data and metadata in separate rings, as shown in example 200, a host cache service can ensure that data and metadata are aligned to memory page boundaries, which minimizes (and even eliminates) any wasted memory that would result if data and metadata were stored together. For example, each data ring may be sized to correspond to the size of a memory page, or to a multiple of the memory page size. Additionally, metadata rings may be sized such that a plurality of contiguously stored metadata rings corresponds to the size of a memory page or to a multiple of the memory page size.

Some embodiments replicate write cache logs between hosts, such as replicating one or more logs from write cache 112a to write cache 112b or vice versa. This replication ensures data reliability and availability. For example, absent replication, if host 101a were to go down (e.g., crash, power down) or become unresponsive before persisting a log from write cache 112a to backing store 118 (e.g., cache 117), that log could become temporarily unavailable (e.g., until host 101a is brought back up or becomes responsive again) or even be lost. Thus, in embodiments, host cache service instances (e.g., cache service 109a, cache service 109b) cooperate with one another to replicate logs across hosts, ensuring the reliability and availability of those logs before they are persisted to backing store 118.

In embodiments, a host cache service commits a write I/O operation (e.g., acknowledges completion of the write I/O operation to a virtual storage controller, a storage driver, etc.) after replication of that operation's corresponding data has been completed. This means that a write I/O operation can be committed before the data written by the operation has been de-staged to backing store 118 while ensuring the reliability and availability of the data written. In embodiments, committing a write I/O operation prior to that data being written to a backing store shortens the I/O path for the I/O operation, which enables lower latency for write I/O operations than would be possible absent the host cache service described herein.

The term quorum is used within the context of replication. As used in this description, and in the claims, the term “quorum” means a minimum number of nodes or replicas that need to participate in an operation in order for the operation to be valid. The purpose of a quorum is to ensure data consistency and availability in the presence of node failures. By requiring a quorum of participants, a system can continue functioning correctly even if some nodes fail. The particular number of nodes that comprise a quorum can vary depending on the replication scheme and/or on the type of operation being performed. For example, a read quorum is the minimum number of participants needed to read a data item. In contrast, a write quorum is the minimum number of participants needed to write or update a data item. In various examples, a quorum may be a majority of nodes in a replica set, a certain percentage of nodes in the replica set, a fixed number of nodes, and the like.

Conventional data replication approaches use two phases: a “send” phase and a “commit” phase. In the send phase, a primary host sends data to one or more secondary hosts that are members of a replication set. Then, in the commit phase, the primary host verifies that data has been committed by a majority of the secondary hosts in the replication set. For example, the data may be committed by persisting or de-staging it to durable storage and thus, a primary host verifies that a majority of secondary hosts have persisted the data to corresponding durable storage. Under these conventional data replication approaches, the primary host only considers the replication complete after verifying that the data has been committed by the majority of the replication set. Notably, if only a minority of the replication set can verify the committing of the data, the replication cannot be considered complete.

Embodiments described herein enable a single-phase commit flow for replicating write cache data. Being single-phase, in this commit flow, there is only one network hop between sending and receiving computer systems for cache data replication, with no need to do a second round network hop between the sending and receiving computer systems for a commit phase. This means that the I/O latency of each replication operation is reduced as compared to conventional two-phase commits.

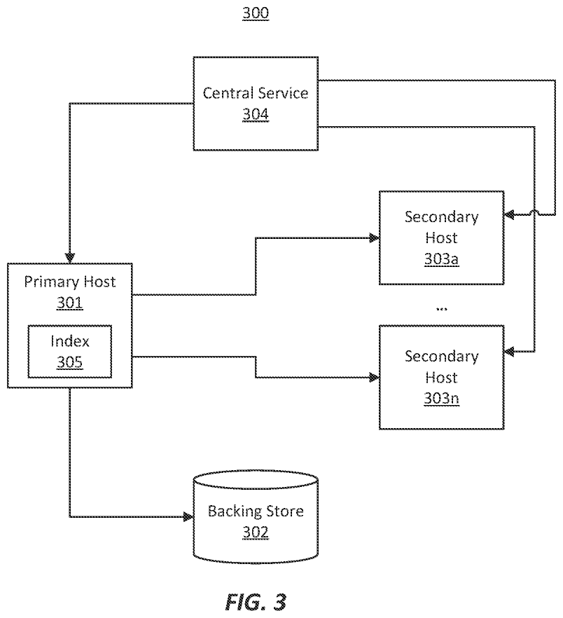

FIG. 3 illustrates an example of a computer architecture 300 for replicating write cache data using a single-phase commit flow. Computer architecture 300 includes a cluster of hosts, including a primary host 301 and one or more secondary hosts (e.g., secondary host 303a to secondary host 303n; collectively, secondary hosts 303). In embodiments, primary host 301 and secondary hosts 303 include one or more of hosts 101. Computer architecture 300 includes also includes a backing store 302 (e.g., backing store 118) and a central service 304.

In embodiments, central service 304 provides cluster-wide consensus guarantees by managing the selection of which host in a cluster of hosts is the primary host and which host(s) are secondary hosts, which avoids situations like split-brain (e.g., where multiple hosts act as primary at the same time). For example, arrows extending from central service 304 to primary host 301 and each of secondary hosts 303 indicate cluster management by central service 304.

In embodiments, a write log can have one of a plurality of statuses at a given host, such as persisted, committed, and de-staged. In embodiments, a persisted log is one that has been persisted locally (e.g., within PMem the host). In embodiments, a committed log is one that has been replicated to a quorum of secondaries and whose corresponding write has been committed. In embodiments, committed logs exist only at primary host 301. In embodiments, a de-staged log is on that has been successfully de-staged to backing store 302. Other statuses are also possible.

In embodiments, primary host 301 receives write I/O requests. Primary host 301 then assigns each write a unique and increasing log identifier, persists the write locally (e.g., to PMem), and replicates the write to secondary hosts 303 (e.g., as indicated by arrows connecting primary host 301 to secondary host 303a and secondary host 303n). In embodiments, once a log is replicated to a quorum of secondary hosts 303, primary host 301 commits the logs (e.g., indicates success of a write to a virtual storage controller) and then de-stages committed logs to backing store 302 (e.g., as indicated by an arrow connecting primary host 301 to backing store 302).

In embodiments, primary host 301 also maintains an index 305 of cached write data and serves read requests (e.g., from VMs or containers) from cached write data based on index 305. In embodiments, primary host 301 indexing is based on dividing LBAs into chunks (e.g., 64 KB chunks), hashing chunk addresses, and mapping hashed chunk addresses to their write-ahead logs.

In embodiments, each secondary host of secondary hosts 303 maintains a replica of the logs it receives from primary host 301 (e.g., within PMem at the secondary host). In embodiments, secondary hosts 303 do not serve reads and do not de-stage logs to backing store 302. However, in the event of a failure of primary host 301, each secondary host has enough information to become primary. In embodiments, secondary hosts 303 lack access to backing store 302 while they are in the secondary role (e.g., in FIG. 3, there are no arrows connecting secondary hosts 303 to backing store 302).

Notably, because secondary hosts 303 do not commit (e.g., persist, de-stage) logs to backing store 302, there is no need for a traditional commit phase during replication (e.g., in which a primary would verify that data has been committed by the majority of secondary hosts in a replication set). Thus, primary host 301 can commit a log and indicate the success of a corresponding write (e.g., to a storage controller, such as virtual storage controller 107a) after the log has been replicated to a quorum of secondaries, all without needing to confirm that those secondary hosts have committed the log themselves.

In embodiments, logs are maintained in sequence at each host (e.g., within one or more ring buffers) based on a log identifier assigned by primary host 301 to the log, and each host (e.g., primary and secondary) maintains a set of pointers within these logs. In embodiments, a pointer-to-persisted (PPL) is the maximum log identifier before which logs are all persisted at the host. In embodiments, a pointer-to-committed (PCL) is the maximum log identifier before which logs are all committed at the host. In embodiments, a PCL exists only at primary host 301. In embodiments, a pointer-to-de-staged (PDL) is the maximum log identifier before which logs are all de-staged. In embodiments, primary host 301 sends its PDL to secondaries.

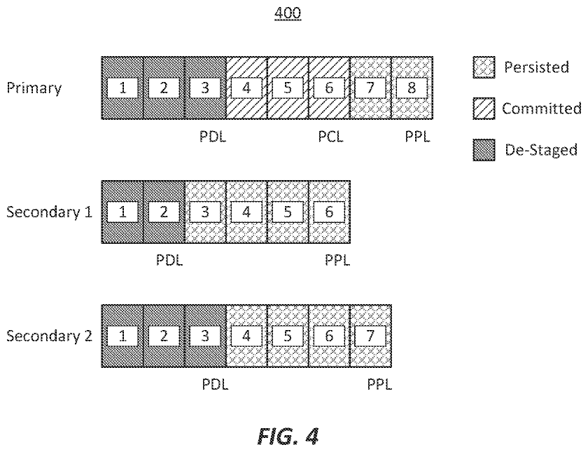

FIG. 4 illustrates an example 400 of log statuses and pointers. In example 400, a primary host (e.g., primary host 301) has a sequence of eight logs (e.g., log identifiers 1-8), a first secondary host (e.g., secondary host 303a) has six of these eight logs, and a second secondary host (e.g., secondary host 303n) has seven of these eight logs. At the primary host, logs with log identifiers 1-3 have the de-staged status, logs with log identifiers 4-6 have the committed status, and logs with log identifiers 7-8 have the persisted status. Thus, as shown, the primary host has a PDL pointing to log identifier three, a PCL pointing to log identifier six, and a PPL pointing to log identifier eight. At the first secondary host, logs with log identifiers 1-2 have the de-staged status, and logs with log identifiers 3-6 have the persisted status. As shown, the first secondary host has a PDL pointing to log identifier two and a PPL pointing to log identifier six. At the second secondary host, logs with log identifiers 1-3 have the de-staged status, and logs with identifiers 4-7 have the persisted status. As shown, the second secondary host has a PDL pointing to log identifier three and a PPL pointing to log identifier seven. Thus, the primary host has de-staged logs with log identifiers 1-3 to a backing store, has successfully replicated logs with log identifiers 4-6 to both secondaries and can de-stage them to the backing store, and has locally stored (e.g., to PMem) logs with log identifiers 7-8 and is in process of replicating those logs to the secondaries.

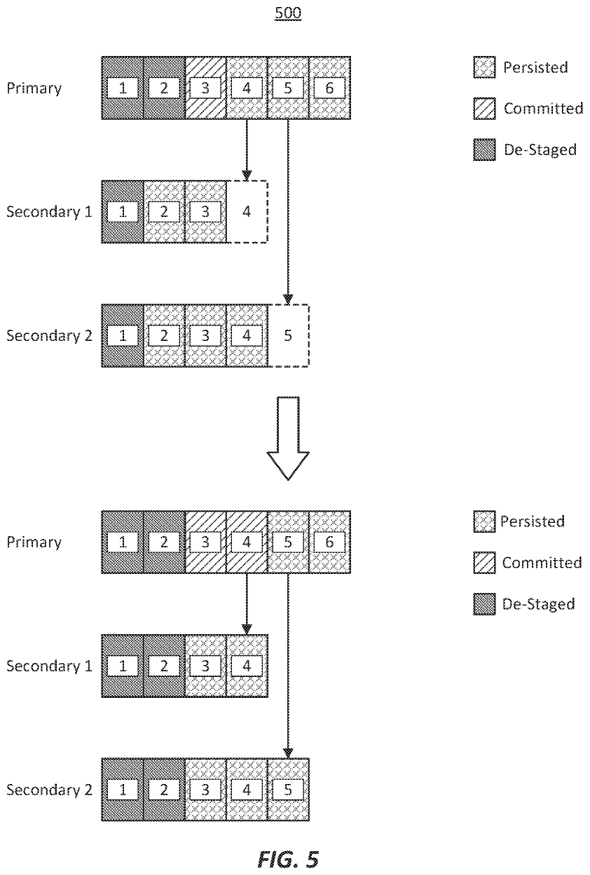

FIG. 5 illustrates an example 500 of log replication. In example 500, a primary host (e.g., primary host 301) has a sequence of six logs (e.g., log identifiers 1-6), a first secondary host (e.g., secondary host 303a) has three of these six logs, and a second secondary host (e.g., secondary host 303n) has four of these six logs. At the primary host, logs with log identifiers 1-2 have the de-staged status, a log with log identifier three has the committed status, and logs with log identifiers 4-6 have the persisted status. At the first secondary host, a log with log identifier one has the de-staged status, and logs with log identifiers 2-4 have the persisted status. At the second secondary host, a log with log identifier one has the de-staged status, and logs with log identifiers 2-4 have the persisted status. As shown, the primary host initiates replication of the log with log identifier four to the first secondary host and initiates replication of the log with log identifier five to the second secondary host. As shown below the arrow, after replication, the primary host commits the log with log identifier four (e.g., because it has been replicated to a quorum of secondary hosts) and de-stages the log with log identifier two (with that status being sent to the secondary hosts, e.g., by the primary host sending a PDL of two to those hosts).

At times, primary host 301 may become unavailable (e.g., due to a crash, a power-down, excessive workload). In embodiments, when primary host 301 becomes unavailable, central service 304 notifies secondary hosts 303 to reject any requests from primary host 301 (e.g., in case primary host 301 becomes available again). Secondary hosts 303 respond to central service 304 with their current PPL. The central service 304 then promotes one of the secondary hosts 303 (e.g., secondary host 303a) to be a “de-stage primary.” Central service 304 selects a secondary with the largest PPL, or that is tied as having the largest PPL, among the secondary hosts as the de-stage primary and instructs the de-stage primary to perform a de-stage. In some embodiments, central service 304 only selects a de-stage primary when at least (N−Q+1) secondaries respond with a PPL, where N is a membership size (e.g., a total number of the secondary hosts 303) and Q is a quorum size. This is because 1) if less than (N−Q+1) secondaries are responsive, there would be insufficient secondaries for further I/O (e.g., due to lack of a quorum), and 2) there needs to be at least (N−Q+1) secondaries to at least select a secondary with the Q^{th} greatest PPL.

In embodiments, the de-stage primary acquires exclusive access to backing store 302, ensuring that only the de-stage primary can write to backing store 302. In embodiments, the de-stage primary may acquire exclusive access to backing store 302 via communications with backing store 302 (e.g., based on the use of a filesystem mechanism, based on communications with a storage controller) and/or via communications with central service 304. Once it has acquired exclusive access to backing store 302, in embodiments, the de-stage primary checks in with central service 304 to ensure that it is still the de-stage primary. Then, the de-stage primary de-stages any logs stored in its memory (e.g. PMem) to backing store 302. After the de-staging is complete, the de-stage primary signals the central service 304 and starts servicing I/O operations as a new primary host. In embodiments, based on the de-stage primary signaling the central service 304, the central service 304 signals the remaining secondary hosts (e.g., secondary host 303n) to sync to the new primary host (e.g., flush logs that the newly promoted primary host has already de-staged) and resume operation in their secondary role.

Additionally, at times, one or more of secondary hosts 303 may become unavailable (e.g., due to a crash, a power-down, or excessive workload). Embodiments provide for a fast recovery from secondary host failure without disrupting cache uptime. In these embodiments, a replication set contains active secondary hosts (e.g., secondary hosts 303), but standby secondary hosts are also available if needed. If primary host 301 cannot replicate a log to a quorum of secondary hosts with its current replication set, central service 304 activates one or more of the standby secondary hosts into the replication set, and primary host 301 sends the log to the newly-activated secondary host(s). In these cases, there may be some logs in the previous replication set that have not been replicated to a full quorum of secondaries. If so, primary host 301 copies the unsuccessful logs to the new replication set, enabling the log replication to be completed to a full quorum of secondaries.

As mentioned, primary host 301 commits a log once that log has been successfully replicated to a quorum of secondary hosts. Conventional replication requires a quorum to have majority support (e.g., a majority of available hosts in a replication set need to commit data for replication to succeed). Embodiments enable a write quorum without majority support (e.g., two of five hosts in a replication set would be sufficient for a write quorum). In embodiments, a write quorum without majority support is enabled by central service 304, which has visibility into the whole replication set.

In traditional networking methods, data transfer between computers typically involves multiple data copies and context switches, which can significantly increase latency and CPU overhead. For example, when data is sent over a network, it is usually copied from the sending application's memory to the operating system kernel memory, then to the network protocol stack, and finally to the network interface card (NIC). Upon reaching the destination, the data is copied in reverse order from the NIC to the destination application's memory. This process is not only time-consuming but also burdens the CPU, which could otherwise be used for processing the actual data.

To address these inefficiencies, Remote Direct Memory Access (RDMA) was developed to enable more direct data transfers. RDMA-capable NICs, often referred to as RDMA Network Interface Cards (RNICs), allow applications on different computers to transfer data directly between their memory spaces without the need for significant CPU intervention. This is achieved by establishing a connection and pre-registering the memory regions involved in the transfer, which allows the RNICs to access the memory directly using Direct Memory Access (DMA) operations.

Some embodiments utilize RDMA technology to replicate write cache logs from a primary host to each secondary host. RDMA technology allows data to be transferred directly from the memory of one computer to the memory of another computer with little or no involvement of the CPU or OS of the remote system. This direct memory-to-memory data transfer can improve throughput and performance while reducing latency, making it particularly useful in high-performance computing and data center environments, such as computer architecture 300. Notably, RDMA can use strict ordering guarantees to determine when data transfers are complete. In embodiments, primary host 301 utilizes RDMA's strict ordering guarantees to efficiently determine that a plurality of replication requests have all been completed successfully at a secondary host. In particular, rather than confirming whether each replication request to a secondary host has succeeded individually, primary host 301 can only verify that the most recent replication request to the secondary host has succeeded. If so, due to RDMA's strict ordering guarantees, primary host 301 can be sure that all the prior replication requests to the secondary host also succeeded.

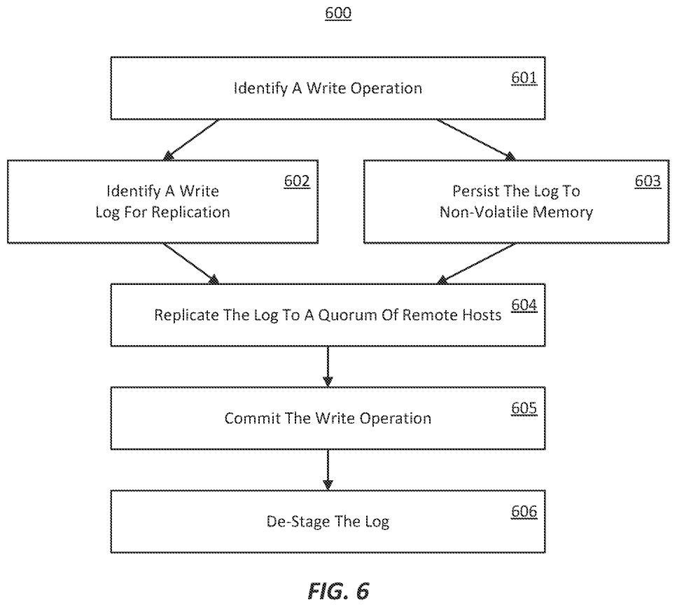

Embodiments are now described in connection with FIG. 6, which illustrates a flow chart of an example method 600 for a primary host to replicate write I/O cache data to a replication set of secondary hosts. In embodiments, instructions for implementing method 600 are encoded as computer-executable instructions stored on a computer storage media that are executable by a processor system to cause a computer system (e.g., primary host 301) to perform method 600.

The following discussion now refers to a number of methods and method acts. Although the method acts are discussed in specific orders or are illustrated in a flow chart as occurring in a particular order, no order is required unless expressly stated or required because an act is dependent on another act being completed prior to the act being performed.

Referring to FIG. 6, in embodiments, method 600 comprises act 601 of identifying a write operation. In some embodiments, act 601 comprises identifying a write I/O operation. For example, primary host 301 receives a write I/O request from a VM or container operating at primary host 301 or from another computer system. In some embodiments, identifying the write I/O operation includes identifying the write I/O operation from a virtual storage controller, such as virtual storage controller 107a.

Method 600 also comprises act 602 of identifying a write log for replication. In some embodiments, act 602 comprises identifying a log to be replicated based on the write I/O operation. For example, primary host 301 creates or identifies a log corresponding to the write I/O operation, which is to be replicated to one or more of secondary hosts 303. For example, primary host 301 creates or identifies a log with separated data (e.g., data written by the write I/O operation) and metadata describing the log (e.g., log identifier, LBA at which the data is written). In embodiments, primary host 301 assigns the log identifier to the log, such that method 600 further includes assigning a unique log identifier to the log.

Method 600 also comprises act 603 of persisting the log to non-volatile memory. In some embodiments, act 603 comprises persisting the log to local non-volatile memory in the computer system. For example, primary host 301 persists the log to non-volatile memory, such as PMem. In some embodiments, act 603 comprises persisting log data to a first ring buffer (e.g., data ring 201) and persisting log metadata to a second ring buffer (e.g., metadata ring 203).

In FIG. 6, no order is required between act 602 and act 603, indicating that in various embodiments, the acts are performed serially (in either order), or in parallel.

Method 600 also comprises act 604 of replicating the log to a quorum of remote hosts. In some embodiments, act 604 comprises replicating the log to a plurality of remote hosts, wherein each remote host of the plurality of remote hosts stores the log in a corresponding local non-volatile memory in the remote host without de-staging the log to a backing store. For example, primary host 301 replicates the log to one or more hosts of secondary hosts 303, each of which then persists the log to its own local non-volatile memory (e.g., PMem). In some embodiments, replicating the log to the plurality of remote hosts includes using RDMA to transfer the log to each remote host.

Method 600 also comprises act 605 of committing the write operation. In some embodiments, act 605 comprises committing the write I/O operation after replicating the log to at least a subset of the plurality of remote hosts that comprises a quorum. For example, after confirming that the log has been replicated to a quorum of secondary hosts 303, primary host 301 commits write I/O operation. In embodiments, this committing includes signaling a source of the write I/O operation (e.g., a VM/container, a storage controller such as virtual storage controller 107a, or a remote computer system). In some embodiments, the quorum includes less than a majority of the plurality of remote hosts.

Method 600 also comprises act 606 of de-staging the log. In some embodiments, act 606 comprises de-staging the log to the backing store based on committing the write I/O operation. For example, primary host 301 de-stages the log to backing store 302.

As discussed, in embodiments, central service 304 manages which host is the primary host and which host(s) are secondary. In some embodiments, method 600 is performed by a computer system that has been promoted from a secondary host to the primary host. In these embodiments, method 600 further includes, prior to identifying the write I/O operation, receiving a first message from a management service requesting that the computer system de-stage persisted logs to the backing store; the computer system acquiring exclusive access to the backing store; the computer system de-staging one or more logs persisted to the local non-volatile memory in the computer system; the computer system sending a second message to the management service indicating completion of the de-staging; and the computer system accepting write I/O operations.

As discussed, in embodiment, a primary host maintains an index (e.g., index 305) of cached write data and serves read requests (e.g., read requests received from VMs or containers) from cached write data based on the index. Thus, in embodiments, method 600 further includes storing a record of the log in an index and, in response to receiving a read I/O request from a cache consumer, using the index to serve data corresponding to the log to a cache consumer. For example, cache service 109a serves data for a read I/O request received from VM 102a from write cache 112a, rather than fetching that data from backing store 118.

Embodiments of the disclosure comprise or utilize a special-purpose or general-purpose computer system (e.g., host 101a, host 101b) that includes computer hardware, such as, for example, a processor system and system memory (e.g., RAM 111a, RAM 111b), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more CPUs, one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (Saas), Platform as a Service (PaaS), Infrastructure as a Service (laaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a computer system that includes a processor system, comprising:
identifying a write input/output (I/O) operation;
identifying a log to be replicated based on the write I/O operation;
persisting the log to local non-volatile memory in the computer system;
replicating the log to a plurality of remote hosts, wherein each remote host of the plurality of remote hosts stores the log in a corresponding local non-volatile memory in the remote host;
committing the write I/O operation after replicating the log to at least a subset of the plurality of remote hosts that comprises a quorum; and
de-staging the log to a backing store based on committing the write I/O operation.

2. The method of claim 1, wherein the log comprises data written by the write I/O operation and metadata describing the log.

3. The method of claim 1, wherein replicating the log to the plurality of remote hosts includes using Remote Direct Memory Access (RDMA) to transfer the log to each remote host.

4. The method of claim 1, wherein the corresponding local non-volatile memory comprises a persistent memory.

5. The method of claim 1, wherein,
identifying the write I/O operation comprises identifying the write I/O operation from a virtual storage controller; and
committing the write I/O operation comprises notifying the virtual storage controller.

6. The method of claim 1, wherein the quorum comprises less than a majority of the plurality of remote hosts.

7. The method of claim 1, wherein the method further comprises, prior to identifying the write I/O operation:
receiving a first message from a management service requesting the computer system to de-stage persisted logs to the backing store;
acquiring exclusive access to the backing store;
de-staging one or more logs persisted to the local non-volatile memory in the computer system;
sending a second message to the management service indicating a completion of de-staging the persisted logs to the backing store; and
accepting write I/O operations.

8. The method of claim 1, wherein the method further comprises assigning a unique log identifier to the log.

9. The method of claim 1, wherein the method further comprises:
storing a record of the log in an index; and
using the index, serving data corresponding to the log in response to a read I/O request.

10. The method of claim 1, wherein persisting the log to the local non-volatile memory in the computer system comprises persisting log data to a first ring buffer, and persisting log metadata to a second ring buffer.

11. The method of claim 1, wherein replicating the log to the plurality of remote hosts comprises each remote host of the plurality of remote hosts storing the log in the corresponding local non-volatile memory in the remote host without de-staging the log to the backing store.

12. A computer system, comprising:
a processor system; and
a computer storage medium that stores computer-executable instructions that are executable by the processor system to at least:
identify a write input/output (I/O) operation;
identify a log to be replicated based on the write I/O operation;
persist the log to local non-volatile memory in the computer system;
replicate the log to a plurality of remote hosts, wherein each remote host of the plurality of remote hosts stores the log in a corresponding local non-volatile memory in the remote host without de-staging the log to a backing store;
commit the write I/O operation after replicating the log to at least a subset of the plurality of remote hosts that comprises a quorum, wherein the quorum comprises less than a majority of the plurality of remote hosts; and
de-stage the log to the backing store based on committing the write I/O operation.

13. The computer system of claim 12, wherein the log comprises data written by the write I/O operation and metadata describing the log.

14. The computer system of claim 12, wherein replicating the log to the plurality of remote hosts includes using Remote Direct Memory Access (RDMA) to transfer the log to each remote host.

15. The computer system of claim 12, wherein the corresponding local non-volatile memory comprises a persistent memory.

16. The computer system of claim 12, wherein,
identifying the write I/O operation comprises identifying the write I/O operation from a virtual storage controller; and
committing the write I/O operation comprises notifying the virtual storage controller.

17. The computer system of claim 12, wherein the computer-executable instructions are also executable by the processor system to, prior to identifying the write I/O operation:
receive a first message from a management service requesting the computer system to de-stage persisted logs to the backing store;
acquire exclusive access to the backing store;
de-stage one or more logs persisted to the local non-volatile memory in the computer system;
send a second message to the management service indicating a completion of de-staging the persisted logs to the backing store; and
accept write I/O operations.

18. The computer system of claim 12, wherein the computer-executable instructions are also executable by the processor system to assign a unique log identifier to the log.

19. The computer system of claim 12, wherein the computer-executable instructions are also executable by the processor system to:
store a record of the log in an index; and
using the index, serve data corresponding to the log to a cache consumer in response to receiving a read I/O request from the cache consumer.

20. A computer storage medium that stores computer-executable instructions that are executable by a processor system to at least:
Identify a write input/output (I/O) operation;
identify a log to be replicated based on the write I/O operation;
persist the log to a persistent non-volatile memory in a computer system;
replicate the log to a plurality of remote hosts, wherein each remote host of the plurality of remote hosts stores the log in a corresponding local non-volatile memory in the remote host without de-staging the log to a backing store;
commit the write I/O operation after replicating the log to at least a subset of the plurality of remote hosts that comprises a quorum; and
de-stage the log to the backing store based on committing the write I/O operation.
